(19) United States
(12) Patent Application Publication
(10) Pub. No.: US 2022/0414747 A1
(43) Pub. Date: Dec. 29, 2022

(54) SELECTING ITEMS FOR A RECEIVING USER TO INCLUDE IN AN ORDER FROM A LIST CREATED FROM A SENDING ENTITY AND TRANSMITTED TO THE RECEIVING USER

(71) Applicant: Maplebear Inc.(dba Instacart), San Francisco, CA (US)

(72) Inventors: Changyao Chen, New York, NY (US); Peng Qi, Menlo Park, CA (US); Weian Sheng, Foster City, CA (US); Chuanwei Ruan, Santa Clara, CA (US); Qiao Jiang, Malden, MA (US)

(21) Appl. No.: 17/358,081

(22) Filed: Jun. 25, 2021

(51) Int. Cl. G06Q 30/06; G06Q 10/08; G06N 20/00

(52) U.S. Cl. CPC G06Q 30/0633; G06Q 30/0643; G06Q 10/087; G06N 20/00

(57) ABSTRACT

An online concierge system enables users to create lists of items and generate a link allowing other receiving users to access a list by selecting the link. When a receiving user selects the link, the online concierge system generates a user-specific list from the original list. The user-specific list includes user-specific items selected for the receiving user that replace items in the original list based on item availability to the receiving user, receiving user preferences, and other receiving user-specific criteria. The receiving user can then view the user-specific items in the user-specific list via an interface allowing the user-specific items in the user-specific list to be included in an order in a single interaction.

### BACKGROUND

This disclosure relates generally to ordering one or more items through an online concierge system, and more specifically to selecting one or more items for inclusion in an order by a receiving user based on a list of items the receiving user obtains from a sending entity.

In current online concierge systems, shoppers (or “pickers”) fulfill orders at a physical warehouse, such as a retailer, on behalf of users as part of an online shopping concierge service. An online concierge system provides an interface to a user identifying items offered by a physical warehouse and receives selections of one or more items for an order from the user. In current online concierge systems, the shoppers may be sent to various warehouses with instructions to fulfill orders for items, and the shoppers then find the items included in the user order in a warehouse.

While conventional online concierge systems allow a user to create and to maintain lists of items for use by the user, the user cannot easily share such a list with another user. A user may forward a page maintained by a conventional online concierge system to another user, but such a page does not account for differences between warehouses available to the user creating the list and the user receiving the list. For example, a list created by a user includes items available to the user via a warehouse selected based on the user's location, so sending the list to another user includes the items available at the selected warehouse, while the other user would be selecting items from a different warehouse or from a warehouse with different items available for purchase than the warehouse selected by the user who created the list. Hence, a user receiving a list from another user often expends time searching for replacement items for various items on the received list to account for a warehouse from which the user receiving the list is purchasing items. This increased time expended selecting items may decrease a likelihood of a user purchasing items from a list received from another user via the online concierge system.

### SUMMARY

An online concierge system receives a list of items from a sending entity of the online concierge system. The list includes information identifying one or more items. Example information identifying an item includes an item identified maintained by the online concierge system, a name of an item, a description of an item, or any other suitable information. In various embodiments, the online concierge system receives an identifier or a name of the list from the sending entity as well. The online concierge system stores the list in association with the sending entity. The list may identify one or more specific items or one or more generic item descriptions in various embodiments. The sending entity may be a user of the online concierge system, a third party system external to the online concierge system, or any other suitable source of content.

To allow other users of the online concierge system to readily view or access the list, the online concierge system generates a link to access the list. For example, the link is a hyperlink to a web page generated by the online concierge system or a deep link to a page of content within an application associated with the online concierge system, allowing a user of a client device displaying the link to access. Alternatively or additionally, the link comprises a bar code or a QR code that, when accessed by an application executing on a client device retrieves a page of content generated by the online concierge system via an application executing on the client device. The online concierge system transmits or otherwise provides the generated link to the sending entity, allowing the sending entity to distribute the generated list to other users. In various embodiments, the generated link is transmissible by the sending entity to other users through any suitable communication channel, including communication channels external to the online concierge system. This allows the sending entity to transmit the list to other users through an application associated with the online concierge system executing on client devices, as well as through communication channels external to an application associated with the online concierge system executing on client devices. For example, the sending entity transmits the link to other users via email or text messaging. The sending entity may additionally or alternatively display the link in one or more web pages served from one or more third party systems external to the online concierge system; the link may be displayed in a web page served by a third party system in any suitable format, such as a displayed link, a button or other interface element, or embedded as an iframe including the list from a domain associated with the online concierge system in a page of content from a domain external to the online concierge system. When the link is a bar code, a QR code, or other machine readable code, the sending entity may display the bar code, QR code, or other machine readable code on physical objects (e.g., packaging of an item, a poster, a wall of a retailer, or any other suitable physical content) or in visual media (e.g., video content, a picture or an image, broadcast media, etc.).

When a receiving user selects the link to access the list, the online concierge system receives a selection of the list that includes information identifying the receiving user and identifying the list. For example, the selection includes an email address of the receiving user or other information identifying the receiving user to the online concierge system. As the receiving user may be in a different location than the sending entity, with different warehouses available to the receiving user, items identified by the list may be inaccessible or unavailable to the receiving user. Similarly, for generic item descriptions included in the list, differences in warehouses available to the receiving user affect specific items available that satisfy a generic item description.

To compensate for differences in item availability between a location of the sending entity who created the list and a receiving user, the online concierge system retrieves information maintained by the online concierge system for the receiving user. The retrieved information includes a location of the receiving user, and may include one or more preferences of the user and prior orders the online concierge system received from the receiving user. The receiving user's location may be retrieved from an account the online concierge system maintains for the receiving user. This allows the online concierge system to leverage information about the receiving user to replace or modify an item included on the list with a comparable item that has a higher probability of being available in the receiving user's location or that satisfies one or more preferences of the receiving user.

From the location for the receiving user, the online concierge system selects a warehouse for the receiving user. For example, the online concierge system selects a warehouse identified by a maximum number of orders the online concierge system retrieved from the receiving user (e.g., identified by a maximum number of orders the online concierge system received from the receiving user within a specific time interval). If the online concierge system has received less than a threshold number of orders from the online concierge system, the online concierge system determines a geographic region including the location for the receiving user and selects a warehouse included in a maximum number of orders specifying locations within the geographic region. Alternatively, the online concierge system receives a selection of a warehouse from the receiving user.

Based on the retrieved information maintained for the receiving user, for each item of the list the online concierge system selects a set of user-specific items associated with an item included in the list and selects a user-specific item from the set corresponding to the item of the list. In various embodiments, the online concierge system selects the set of user-specific items based on availabilities of items at a warehouse selected for the receiving user. Based on the warehouse selected for the receiving user, the online concierge system determines an availability of the item included in the list by applying a machine-learned item availability model to the combination of selected warehouse and item included in the list. In response to the availability of the item included in the list at the selected warehouse equaling or exceeding a threshold availability, the online concierge system selects the item included on the list as the user-specific item.

However, in response to the availability of the item included in the list at the selected warehouse being less than the threshold availability, the online concierge system selects a set of user-specific items corresponding to the item included in the list. For example, the online concierge system retrieves information stored in association with the item included in the list previously purchased by the receiving user and selects one or more replacement items stored in association with the receiving user for the item included in the list. The online concierge system may account for probabilities of the receiving user purchasing various replacement items if multiple replacement items are stored in association with the receiving user.

Additionally or alternatively, the online concierge system retrieves a taxonomy of items offered by the selected warehouse for the receiving user from an item catalog received from the selected warehouse, with different levels in the taxonomy providing different levels of specificity about items included in the levels. In various embodiments, the taxonomy identifies a generic item description and associates one or more specific items with the generic item identifier. For example, a generic item description identifies “milk,” and the taxonomy associates identifiers of different milk items (e.g., milk offered by different brands, milk having one or more different attributes, etc.), with the generic item identifier. Thus, the taxonomy maintains associations between a generic item description and specific items offered by the selected warehouse marching the generic item description. In some embodiments, different levels in the taxonomy identify items with differing levels of specificity based on any suitable attribute or combination of attributes of the items. For example, different levels of the taxonomy specify different combinations of attributes for items, so items in lower levels of the hierarchical taxonomy have a greater number of attributes, corresponding to greater specificity in a generic item description, while items in higher levels of the hierarchical taxonomy have a fewer number of attributes, corresponding to less specificity in a generic item description. In various embodiments, higher levels in the taxonomy include less detail about items, so greater numbers of items are included in higher levels (e.g., higher levels include a greater number of items satisfying a broader generic item description). Similarly, lower levels in the taxonomy include greater detail about items, so fewer numbers of items are included in the lower levels (e.g., higher levels include a fewer number of items satisfying a more specific generic item description). The taxonomy may be received from the selected warehouse in various embodiments. In other embodiments, the online concierge system maintains the taxonomy and applies a trained classification module to an item catalog received from the selected warehouse to include different items in levels of the taxonomy, so application of the trained classification model associates specific items with generic item descriptions corresponding to levels within the taxonomy. In some embodiments, the online concierge system stores different taxonomies that each correspond to a specific warehouse and retrieves a taxonomy stored by the online concierge system corresponding to the selected warehouse for the receiving user.

From the retrieved taxonomy, the online concierge system determines a generic item description corresponding to an item included on the list and selects the set of user-specific items as other items associated with the generic item description corresponding to the item included on the list from the taxonomy. In some embodiments, the online concierge system selects the user-specific item from the set based on items associated with the generic item description corresponding to the item included in the list from the taxonomy based on inclusion of items in prior orders from the receiving user. In other embodiments, the online concierge system applies a trained purchase model to user-specific items of the user-specific item set and selects the user-specific item from the set based on probabilities of the receiving user purchasing different user-specific items of the set. In some embodiments, an entity associated with a user-specific item in the set or the sending entity from whom the online concierge system received the list provides the online concierge system with compensation for selecting the user-specific item from the set. The online concierge system accounts for compensation received by the online concierge system as well as probabilities of the receiving user purchasing various user-specific items of the set to select a user-specific item of the set. In other embodiments, the online concierge system selects a user-specific item from the set based on availabilities of each user-specific item of the set.

In some embodiments, the sending entity specifies one or more items in the list as unable to be replaced. For an item specified as unable to replaced, the online concierge system selects the item in the list as the user-specific item for the item in the list. This prevents the online concierge system from replacing certain items identified by the sending entity with other user-specific items, allowing the sending entity to encourage purchase of one or more items specified as unable to be replaced or to increase awareness of one or more items included in the list that are specified as unable to be replaced.

For a generic item description included in the list, the online concierge system selects the set of user-specific items associated with the generic item description from the retrieved taxonomy. In various embodiments, the set of user-specific items includes each specific item associated with the generic item description by the retrieved taxonomy. The online concierge system may account for prior inclusion of user-specific items within associated with the generic item description by other users of the online concierge system. For example, the online concierge system selects a set of user-specific items associated with the generic item description that were included in at least a threshold number or a threshold percentage of orders previously received from users (e.g., orders received by the online concierge system within a specific time interval). The online concierge system may account for the location determined for the receiving user when selecting the set of user-specific items in some embodiments so the set includes specific items associated with the generic item description that were included in at least at a threshold number or a threshold percentage of previously received orders (e.g., orders received by the online concierge system within a specific time interval) that identified locations within a threshold distance of the location determined for the receiving user.

In some embodiments, the online concierge system selects the user-specific item from the set based on items associated with the generic item description corresponding to the item included in the list from the taxonomy based on inclusion of items in prior orders from the receiving user. In other embodiments, the online concierge system applies a trained purchase model to user-specific items of the user-specific item set and selects the user-specific item from the set based on probabilities of the receiving user purchasing different user-specific items of the set. In some embodiments, an entity associated with a user-specific item in the set or the sending entity from whom the online concierge system received the list provides the online concierge system with compensation for selecting the user-specific item from the set. The online concierge system accounts for compensation received by the online concierge system as well as probabilities of the receiving user purchasing various user-specific items of the set to select a user-specific item of the set. In other embodiments, the online concierge system selects a user-specific item from the set based on availabilities of each user-specific item of the set.

From the user-specific items selected by the online concierge system for items included in the list, the online concierge system generates a user-specific list. The user-specific list identifies the user-specific items selected for the receiving user for each item included on the list. When the list includes one or more items specified as unable to be replaced, the user-specific list identifies the items specified as unable to be replaced that were included in the list by the sending entity. The online concierge system subsequently transmits an interface describing the user-specific list to a client device of the receiving user for display. For example, the interface includes names or descriptions of each user-specific item included in the user-specific list, and may include one or more images of user-specific items included in the user-specific list. The interface also identifies the warehouse selected for the receiving user In various embodiments, the interface includes an interface element, such as a button or a link, that, when selected by the receiving user includes each item in the user-specific list in an order for fulfillment by the online concierge system. This allows the receiving user to generate an order for the user-specific items from the user-specific list with a single interaction with the online concierge system, simplifying order creation by the receiving user. Additionally, the interface allows the receiving user to modify the user-specific list by removing items from or adding items to the user-specific list or by replacing a user-specific item in the user-specific list with an alternative item. The receiving user may subsequently select the interface element to include the items in the modified user-specific list in an order for fulfillment by the online concierge system.

### BRIEF DESCRIPTION OF THE DRAWINGS

FIG. 1 illustrates an environment of an online shopping concierge service, according to one embodiment.

FIG. 2 is a diagram of an online shopping concierge system, according to one embodiment.

FIG. 3A is a diagram of a customer mobile application (CMA), according to one embodiment.

FIG. 3B is a diagram of a shopper mobile application (SMA), according to one embodiment.

FIG. 4 is flowchart illustrating a process for predicting inventory availability, according to one embodiment.

FIG. 5 is a flowchart of a method for an online concierge system selecting one or more items for a receiving user based on a list of items obtained from a sending entity, according to one embodiment.

FIG. 6 is a conceptual diagram of a method for an online concierge system selecting one or more items for a receiving user based on a list of items obtained from a sending entity, in accordance with an embodiment.

The figures depict embodiments of the present disclosure for purposes of illustration only. One skilled in the art will readily recognize from the following description that alternative embodiments of the structures and methods illustrated herein may be employed without departing from the principles, or benefits touted, of the disclosure described herein.

### DETAILED DESCRIPTION

### System Overview

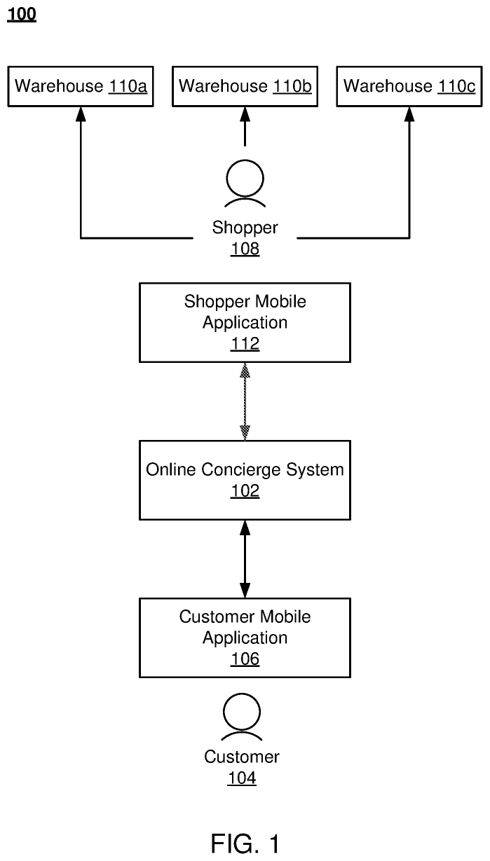

FIG. 1 illustrates an environment 100 of an online platform, according to one embodiment. The figures use like reference numerals to identify like elements. A letter after a reference numeral, such as “110a,” indicates that the text refers specifically to the element having that particular reference numeral. A reference numeral in the text without a following letter, such as “110,” refers to any or all of the elements in the figures bearing that reference numeral. For example, “110” in the text refers to reference numerals “110a” and/or “110b” in the figures.

The environment 100 includes an online concierge system 102. The system 102 is configured to receive orders from one or more users 104 (only one is shown for the sake of simplicity). An order specifies a list of goods (items or products) to be delivered to the user 104. The order also specifies the location to which the goods are to be delivered, and a time window during which the goods should be delivered. In some embodiments, the order specifies one or more retailers from which the selected items should be purchased. The user may use a customer mobile application (CMA) 106 to place the order; the CMA 106 is configured to communicate with the online concierge system 102.

The online concierge system 102 is configured to transmit orders received from users 104 to one or more shoppers 108. A shopper 108 may be a contractor, employee, other person (or entity), robot, or other autonomous device enabled to fulfill orders received by the online concierge system 102. The shopper 108 travels between a warehouse and a delivery location (e.g., the user's home or office). A shopper 108 may travel by car, truck, bicycle, scooter, foot, or other mode of transportation. In some embodiments, the delivery may be partially or fully automated, e.g., using a self-driving car. The environment 100 also includes three warehouses 110a, 110b, and 110c (only three are shown for the sake of simplicity; the environment could include hundreds of warehouses). The warehouses 110 may be physical retailers, such as grocery stores, discount stores, department stores, etc., or non-public warehouses storing items that can be collected and delivered to users. Each shopper 108 fulfills an order received from the online concierge system 102 at one or more warehouses 110, delivers the order to the user 104, or performs both fulfillment and delivery. In one embodiment, shoppers 108 make use of a shopper mobile application 112 which is configured to interact with the online concierge system 102.

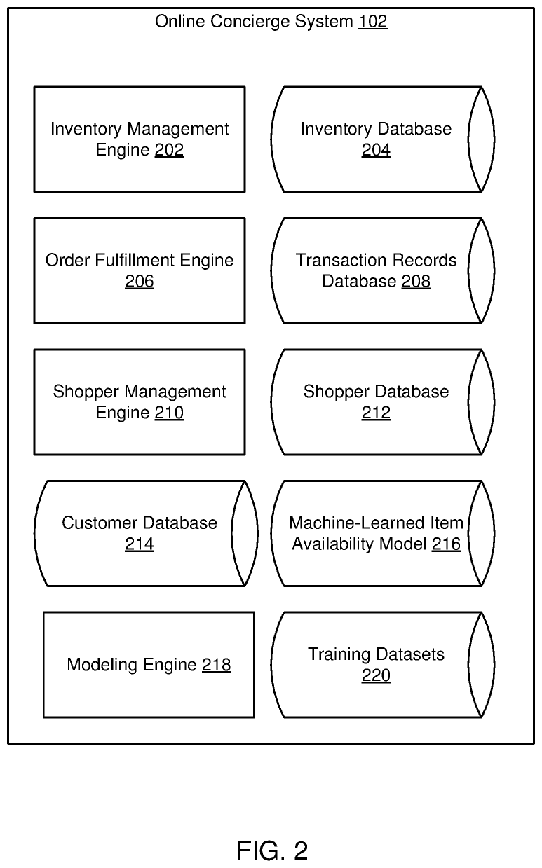

FIG. 2 is a diagram of an online concierge system 102, according to one embodiment. The online concierge system 102 includes an inventory management engine 202, which interacts with inventory systems associated with each warehouse 110. In one embodiment, the inventory management engine 202 requests and receives inventory information maintained by the warehouse 110. The inventory of each warehouse 110 is unique and may change over time. The inventory management engine 202 monitors changes in inventory for each participating warehouse 110. The inventory management engine 202 is also configured to store inventory records in an inventory database 204. The inventory database 204 may store information in separate records—one for each participating warehouse 110—or may consolidate or combine inventory information into a unified record. Inventory information includes both qualitative and qualitative information about items, including size, color, weight, SKU, serial number, and so on. In one embodiment, the inventory database 204 also stores purchasing rules associated with each item, if they exist. For example, age-restricted items such as alcohol and tobacco are flagged accordingly in the inventory database 204. Additional inventory information useful for predicting the availability of items may also be stored in the inventory database 204. For example, for each item-warehouse combination (a particular item at a particular warehouse), the inventory database 204 may store a time that the item was last found, a time that the item was last not found (a shopper looked for the item but could not find it), the rate at which the item is found, and the popularity of the item.

In various embodiments, the inventory management engine 202 maintains a taxonomy of items offered for purchase by one or more warehouses 110. For example, the inventory management engine 202 receives an item catalog from a warehouse 110 identifying items offered for purchase by the warehouse 110. From the item catalog, the inventory management engine 202 determines a taxonomy of items offered by the warehouse 110. different levels in the taxonomy providing different levels of specificity about items included in the levels. In various embodiments, the taxonomy identifies a generic item description and associates one or more specific items with the generic item identifier. For example, a generic item description identifies “milk,” and the taxonomy associates identifiers of different milk items (e.g., milk offered by different brands, milk having one or more different attributes, etc.), with the generic item identifier. Thus, the taxonomy maintains associations between a generic item description and specific items offered by the warehouse 110 marching the generic item description. In some embodiments, different levels in the taxonomy identify items with differing levels of specificity based on any suitable attribute or combination of attributes of the items. For example, different levels of the taxonomy specify different combinations of attributes for items, so items in lower levels of the hierarchical taxonomy have a greater number of attributes, corresponding to greater specificity in a generic item description, while items in higher levels of the hierarchical taxonomy have a fewer number of attributes, corresponding to less specificity in a generic item description. In various embodiments, higher levels in the taxonomy include less detail about items, so greater numbers of items are included in higher levels (e.g., higher levels include a greater number of items satisfying a broader generic item description). Similarly, lower levels in the taxonomy include greater detail about items, so fewer numbers of items are included in the lower levels (e.g., higher levels include a fewer number of items satisfying a more specific generic item description). The taxonomy may be received from a warehouse 110 in various embodiments. In other embodiments, the inventory management engine 202 applies a trained classification module to an item catalog received from a warehouse 110 to include different items in levels of the taxonomy, so application of the trained classification model associates specific items with generic item descriptions corresponding to levels within the taxonomy

Inventory information provided by the inventory management engine 202 may supplement the training datasets 220. Inventory information provided by the inventory management engine 202 may not necessarily include information about the outcome of picking a delivery order associated with the item, whereas the data within the training datasets 220 is structured to include an outcome of picking a delivery order (e.g., if the item in an order was picked or not picked).

The online concierge system 102 also includes an order fulfillment engine 206 which is configured to synthesize and display an ordering interface to each user 104 (for example, via the customer mobile application 106). The order fulfillment engine 206 is also configured to access the inventory database 204 in order to determine which products are available at which warehouse 110. The order fulfillment engine 206 may supplement the product availability information from the inventory database 204 with an item availability predicted by the machine-learned item availability model 216. The order fulfillment engine 206 determines a sale price for each item ordered by a user 104. Prices set by the order fulfillment engine 206 may or may not be identical to in-store prices determined by retailers (which is the price that users 104 and shoppers 108 would pay at the retail warehouses). The order fulfillment engine 206 also facilitates transactions associated with each order. In one embodiment, the order fulfillment engine 206 charges a payment instrument associated with a user 104 when he/she places an order. The order fulfillment engine 206 may transmit payment information to an external payment gateway or payment processor. The order fulfillment engine 206 stores payment and transactional information associated with each order in a transaction records database 208.

In some embodiments, the order fulfillment engine 206 also shares order details with warehouses 110. For example, after successful fulfillment of an order, the order fulfillment engine 206 may transmit a summary of the order to the appropriate warehouses 110. The summary may indicate the items purchased, the total value of the items, and in some cases, an identity of the shopper 108 and user 104 associated with the transaction. In one embodiment, the order fulfillment engine 206 pushes transaction and/or order details asynchronously to retailer systems. This may be accomplished via use of webhooks, which enable programmatic or system-driven transmission of information between web applications. In another embodiment, retailer systems may be configured to periodically poll the order fulfillment engine 206, which provides detail of all orders which have been processed since the last request.

The order fulfillment engine 206 may interact with a shopper management engine 210, which manages communication with and utilization of shoppers 108. In one embodiment, the shopper management engine 210 receives a new order from the order fulfillment engine 206. The shopper management engine 210 identifies the appropriate warehouse to fulfill the order based on one or more parameters, such as a probability of item availability determined by a machine-learned item availability model 216, the contents of the order, the inventory of the warehouses, and the proximity to the delivery location. The shopper management engine 210 then identifies one or more appropriate shoppers 108 to fulfill the order based on one or more parameters, such as the shoppers' proximity to the appropriate warehouse 110 (and/or to the user 104), his/her familiarity level with that particular warehouse 110, and so on. Additionally, the shopper management engine 210 accesses a shopper database 212 which stores information describing each shopper 108, such as his/her name, gender, rating, previous shopping history, and so on.

As part of fulfilling an order, the order fulfillment engine 206 and/or shopper management engine 210 may access a user database 214 which stores information describing each user. This information could include each user's name, address, gender, shopping preferences, favorite items, stored payment instruments, and so on.

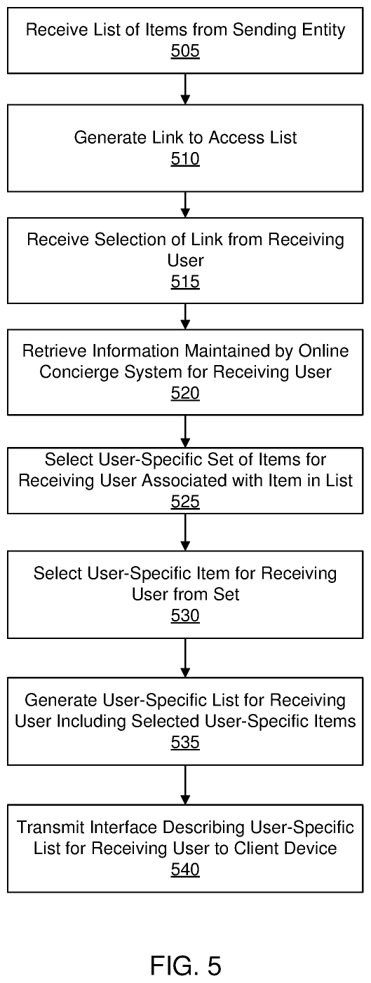

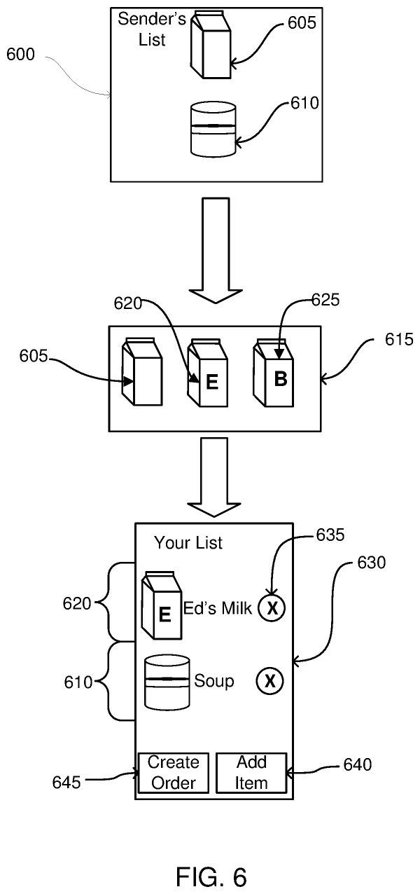

In various embodiments, the order fulfillment engine 206 leverages a taxonomy of items maintained by the inventory management engine 202 to simplify order creation for a user. In various embodiments, the order fulfillment engine 206 receives a selection by a receiving user of a list of items obtained from a different sending entity. As further described below in conjunction with FIGS. 5 and 6, the list includes one or more items and may include one or more generic item description for inclusion in an order from the receiving user. To account for different item availabilities for the receiving user and the sending entity, the order fulfillment engine 206 retrieves a taxonomy for a warehouse 110 for fulfilling an order for the receiving user. From the obtained taxonomy, the order fulfillment engine 206 selects a set of user-specific items for each item or for each generic item description included on the list. From the sets of user-specific items for each item or generic item description included on the list, the order fulfillment engine 206 selects a user-specific item for the receiving user, as further described below in conjunction with FIGS. 5 and 6. For example, the order fulfillment engine 206 applies a trained purchase model to each receiving user item of the set, determining a probability of the receiving user purchasing each user-specific item of the set. Based on the determined probabilities, the order fulfillment engine 206 selects a user-specific item from the set. The order fulfillment engine 206 generates an interface for display to the receiving user, such as through the customer mobile application 106 that is populated with information identifying the user-specific items selected for the receiving user from the list obtained from the sending entity, allowing the order fulfillment engine 206 to account for differences in items available to the receiving user and to the sending entity to simplify use of the list from the sending entity to generate an order based on the list. The interface includes an interface element that, when selected by the receiving user, generates an order including the user-specific items, simplifying creation of an order by the receiving user from the list.

### Machine Learning Models

The online concierge system 102 further includes a machine-learned item availability model 216, a modeling engine 218, and training datasets 220. The modeling engine 218 uses the training datasets 220 to generate the machine-learned item availability model 216. The machine-learned item availability model 216 can learn from the training datasets 220, rather than follow only explicitly programmed instructions. The inventory management engine 202, order fulfillment engine 206, and/or shopper management engine 210 can use the machine-learned item availability model 216 to determine a probability that an item is available at a warehouse 110. The machine-learned item availability model 216 may be used to predict item availability for items being displayed to or selected by a user or included in received delivery orders. A single machine-learned item availability model 216 is used to predict the availability of any number of items.

The machine-learned item availability model 216 can be configured to receive as inputs information about an item, the warehouse for picking the item, and the time for picking the item. The machine-learned item availability model 216 may be adapted to receive any information that the modeling engine 218 identifies as indicators of item availability. At minimum, the machine-learned item availability model 216 receives information about an item-warehouse pair, such as an item in a delivery order and a warehouse at which the order could be fulfilled. Items stored in the inventory database 204 may be identified by item identifiers. As described above, various characteristics, some of which are specific to the warehouse (e.g., a time that the item was last found in the warehouse, a time that the item was last not found in the warehouse, the rate at which the item is found, the popularity of the item) may be stored for each item in the inventory database 204. Similarly, each warehouse may be identified by a warehouse identifier and stored in a warehouse database along with information about the warehouse. A particular item at a particular warehouse may be identified using an item identifier and a warehouse identifier. In other embodiments, the item identifier refers to a particular item at a particular warehouse, so that the same item at two different warehouses is associated with two different identifiers. For convenience, both of these options to identify an item at a warehouse are referred to herein as an “item-warehouse pair.” Based on the identifier(s), the online concierge system 102 can extract information about the item and/or warehouse from the inventory database 204 and/or warehouse database and provide this extracted information as inputs to the item availability model 216.

The machine-learned item availability model 216 contains a set of functions generated by the modeling engine 218 from the training datasets 220 that relate the item, warehouse, and timing information, and/or any other relevant inputs, to the probability that the item is available at a warehouse. Thus, for a given item-warehouse pair, the machine-learned item availability model 216 outputs a probability that the item is available at the warehouse. The machine-learned item availability model 216 constructs the relationship between the input item-warehouse pair, timing, and/or any other inputs and the availability probability (also referred to as “availability”) that is generic enough to apply to any number of different item-warehouse pairs. In some embodiments, the probability output by the machine-learned item availability model 216 includes a confidence score. The confidence score may be the error or uncertainty score of the output availability probability and may be calculated using any standard statistical error measurement. In some examples, the confidence score is based in part on whether the item-warehouse pair availability prediction was accurate for previous delivery orders (e.g., if the item was predicted to be available at the warehouse and not found by the shopper, or predicted to be unavailable but found by the shopper). In some examples, the confidence score is based in part on the age of the data for the item, e.g., if availability information has been received within the past hour, or the past day. The set of functions of the item availability model 216 may be updated and adapted following retraining with new training datasets 220. The machine-learned item availability model 216 may be any machine learning model, such as a neural network, boosted tree, gradient boosted tree or random forest model. In some examples, the machine-learned item availability model 216 is generated from XGBoost algorithm.

The item probability generated by the machine-learned item availability model 216 may be used to determine instructions delivered to the user 104 and/or shopper 108, as described in further detail below.

The training datasets 220 relate a variety of different factors to known item availabilities from the outcomes of previous delivery orders (e.g. if an item was previously found or previously unavailable). The training datasets 220 include the items included in previous delivery orders, whether the items in the previous delivery orders were picked, warehouses associated with the previous delivery orders, and a variety of characteristics associated with each of the items (which may be obtained from the inventory database 204). Each piece of data in the training datasets 220 includes the outcome of a previous delivery order (e.g., if the item was picked or not). The item characteristics may be determined by the machine-learned item availability model 216 to be statistically significant factors predictive of the item's availability. For different items, the item characteristics that are predictors of availability may be different. For example, an item type factor might be the best predictor of availability for dairy items, whereas a time of day may be the best predictive factor of availability for vegetables. For each item, the machine-learned item availability model 216 may weight these factors differently, where the weights are a result of a “learning” or training process on the training datasets 220. The training datasets 220 are very large datasets taken across a wide cross section of warehouses, shoppers, items, warehouses, delivery orders, times and item characteristics. The training datasets 220 are large enough to provide a mapping from an item in an order to a probability that the item is available at a warehouse. In addition to previous delivery orders, the training datasets 220 may be supplemented by inventory information provided by the inventory management engine 202. In some examples, the training datasets 220 are historic delivery order information used to train the machine-learned item availability model 216, whereas the inventory information stored in the inventory database 204 include factors input into the machine-learned item availability model 216 to determine an item availability for an item in a newly received delivery order. In some examples, the modeling engine 218 may evaluate the training datasets 220 to compare a single item's availability across multiple warehouses to determine if an item is chronically unavailable. This may indicate that an item is no longer manufactured. The modeling engine 218 may query a warehouse 110 through the inventory management engine 202 for updated item information on these identified items.

Additionally, the modeling engine 218 maintains a trained purchase model that outputs a probability of the user purchasing an item. The trained purchase model accounts for times when the user previously purchased an item, such as a relative time from a previously received order including the item to a time when the model is applied, as well as attributes of the item (e.g., a type of the item, a quantity or an amount of the item that was previously purchased, a brand of the item). The trained purchase model may include a decay constant that decreases a weighting of purchases of the items over time, so purchases of the item at longer time intervals from the time when the trained purchase model is applied have lower weights than weights of purchases at the item at shorter time intervals from the time when the trained purchase model is applied. Additionally, the trained purchase model accounts for a frequency with which the user purchases an item, which increases a likelihood of the user purchasing an item if the user more frequently purchases the item. Other example factors used by the trained purchase model to determine the likelihood of a user purchasing an item include: a time interval between prior orders including the item received from the user, a frequency with which the item is included in prior orders received from the user, times when orders including the item were previously received from the user, preferences of the user, and any other suitable information. The trained purchase model may be trained using any suitable method or combination of methods (e.g., supervised learning, unsupervised learning, semi-supervised learning, etc.).

### Machine Learning Factors

The training datasets 220 include a time associated with previous delivery orders. In some embodiments, the training datasets 220 include a time of day at which each previous delivery order was placed. Time of day may impact item availability, since during high-volume shopping times, items may become unavailable that are otherwise regularly stocked by warehouses. In addition, availability may be affected by restocking schedules, e.g., if a warehouse mainly restocks at night, item availability at the warehouse will tend to decrease over the course of the day. Additionally, or alternatively, the training datasets 220 include a day of the week previous delivery orders were placed. The day of the week may impact item availability, since popular shopping days may have reduced inventory of items or restocking shipments may be received on particular days. In some embodiments, training datasets 220 include a time interval since an item was previously picked in a previously delivery order. If an item has recently been picked at a warehouse, this may increase the probability that it is still available. If there has been a long time interval since an item has been picked, this may indicate that the probability that it is available for subsequent orders is low or uncertain. In some embodiments, training datasets 220 include a time interval since an item was not found in a previous delivery order. If there has been a short time interval since an item was not found, this may indicate that there is a low probability that the item is available in subsequent delivery orders. And conversely, if there is has been a long time interval since an item was not found, this may indicate that the item may have been restocked and is available for subsequent delivery orders. In some examples, training datasets 220 may also include a rate at which an item is typically found by a shopper at a warehouse, a number of days since inventory information about the item was last received from the inventory management engine 202, a number of times an item was not found in a previous week, or any number of additional rate or time information. The relationships between this time information and item availability are determined by the modeling engine 218 training a machine learning model with the training datasets 220, producing the machine-learned item availability model 216.

The training datasets 220 include item characteristics. In some examples, the item characteristics include a department associated with the item. For example, if the item is yogurt, it is associated with the dairy department. The department may be the bakery, beverage, nonfood and pharmacy, produce and floral, deli, prepared foods, meat, seafood, dairy, the meat department, or dairy department, or any other categorization of items used by the warehouse. The department associated with an item may affect item availability, since different departments have different item turnover rates and inventory levels. In some examples, the item characteristics include an aisle of the warehouse associated with the item. The aisle of the warehouse may affect item availability, since different aisles of a warehouse may be more frequently re-stocked than others. Additionally, or alternatively, the item characteristics include an item popularity score. The item popularity score for an item may be proportional to the number of delivery orders received that include the item. An alternative or additional item popularity score may be provided by a retailer through the inventory management engine 202. In some examples, the item characteristics include a product type associated with the item. For example, if the item is a particular brand of a product, then the product type will be a generic description of the product type, such as “milk” or “eggs.” The product type may affect the item availability, since certain product types may have a higher turnover and re-stocking rate than others or may have larger inventories in the warehouses. In some examples, the item characteristics may include a number of times a shopper was instructed to keep looking for the item after he or she was initially unable to find the item, a total number of delivery orders received for the item, whether or not the product is organic, vegan, gluten free, or any other characteristics associated with an item. The relationships between item characteristics and item availability are determined by the modeling engine 218 training a machine learning model with the training datasets 220, producing the machine-learned item availability model 216.

The training datasets 220 may include additional item characteristics that affect the item availability and can therefore be used to build the machine-learned item availability model 216 relating the delivery order for an item to its predicted availability. The training datasets 220 may be periodically updated with recent previous delivery orders. The training datasets 220 may be updated with item availability information provided directly from shoppers 108. Following updating of the training datasets 220, a modeling engine 218 may retrain a model with the updated training datasets 220 and produce a new machine-learned item availability model 216.

### Customer Mobile Application

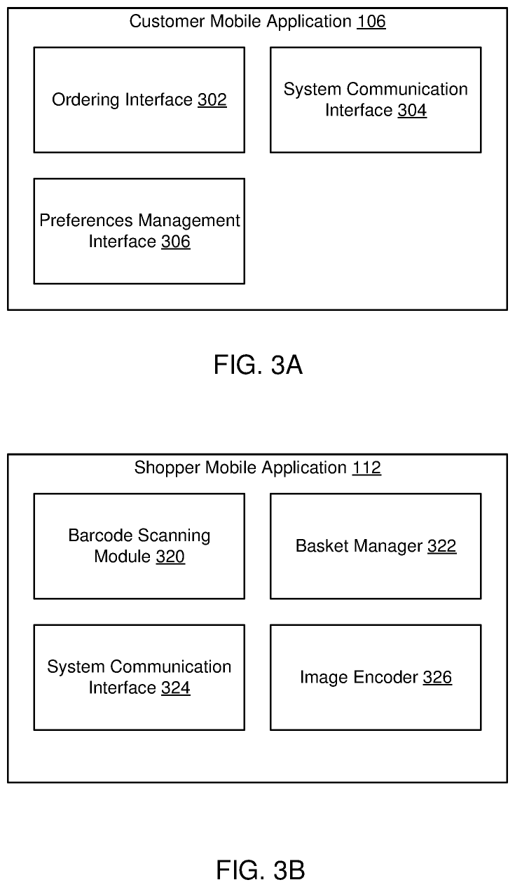

FIG. 3A is a diagram of the customer mobile application (CMA) 106, according to one embodiment. The CMA 106 includes an ordering interface 302, which provides an interactive interface with which the user 104 can browse through and select products and place an order. The CMA 106 also includes a system communication interface 304 which, among other functions, receives inventory information from the online shopping concierge system 102 and transmits order information to the system 102. The CMA 106 also includes a preferences management interface 306 which allows the user 104 to manage basic information associated with his/her account, such as his/her home address and payment instruments. The preferences management interface 306 may also allow the user to manage other details such as his/her favorite or preferred warehouses 110, preferred delivery times, special instructions for delivery, and so on.

### Shopper Mobile Application

FIG. 3B is a diagram of the shopper mobile application (SMA) 112, according to one embodiment. The SMA 112 includes a barcode scanning module 320 which allows a shopper 108 to scan an item at a warehouse 110 (such as a can of soup on the shelf at a grocery store). The barcode scanning module 320 may also include an interface which allows the shopper 108 to manually enter information describing an item (such as its serial number, SKU, quantity and/or weight) if a barcode is not available to be scanned. SMA 112 also includes a basket manager 322 which maintains a running record of items collected by the shopper 108 for purchase at a warehouse 110. This running record of items is commonly known as a “basket”. In one embodiment, the barcode scanning module 320 transmits information describing each item (such as its cost, quantity, weight, etc.) to the basket manager 322, which updates its basket accordingly. The SMA 112 also includes a system communication interface 324 which interacts with the online shopping concierge system 102. For example, the system communication interface 324 receives an order from the system 102 and transmits the contents of a basket of items to the system 102. The SMA 112 also includes an image encoder 326 which encodes the contents of a basket into an image. For example, the image encoder 326 may encode a basket of goods (with an identification of each item) into a QR code which can then be scanned by an employee of the warehouse 110 at check-out.

### Predicting Inventory Availability

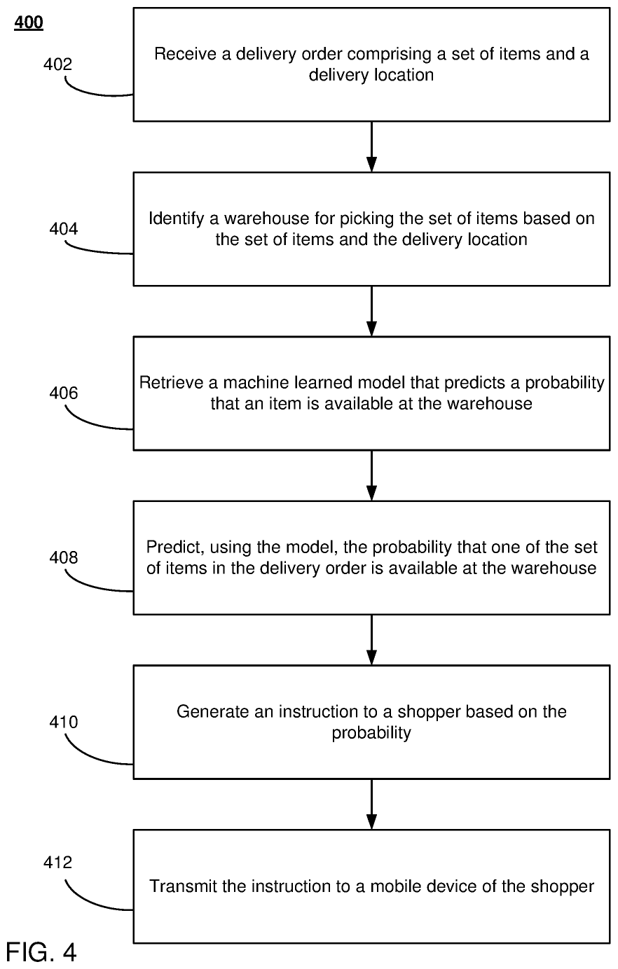

As described with reference to FIG. 2, the machine-learned item availability model 216 of the online concierge system 102 can determine an availability of an item requested by the user 104. FIG. 4 is a flowchart illustrating a process 400 for predicting inventory availability, according to one embodiment. The online concierge system 102 receives 402 a delivery order that includes a set of items and a delivery location. The delivery location may be any location associated with a user, such as a user's home or office. The delivery location may be stored with the user location in the user database 214. Based on the delivery order, the online concierge system 102 identifies a warehouse 404 for picking the set of items in the delivery order based on the set of items and the delivery location. In some cases, the user specifies a particular warehouse or set of warehouses (e.g., a particular grocery store or chain of grocery stores) in the order. In other cases, the online concierge system 102 selects the warehouse based on the items and the delivery location. In some examples, there are a number of different possible warehouses that the set of items may be picked from. The warehouses may be identified by the order fulfillment engine 206 based on warehouses stored by the inventory management engine 202, and warehouses are identified with a suitable inventory and within a threshold distance of the delivery address. In some embodiments, a single delivery order can be split into multiple orders and picked at multiple warehouses, e.g., if the items cannot be fulfilled at a single warehouse. In this example, each possible warehouse is input into the machine-learned item availability model 216.

After the warehouses are identified, the online concierge system 102 retrieves 406 the machine-learned item availability model 216 that predicts a probability that an item is available at the warehouse. The items in the delivery order and the identified warehouses are input into the machine-learned item availability model 216. For example, the online concierge system 102 may input the item, warehouse, and timing characteristics for each item-warehouse pair into the machine-learned item availability model 216 to assess the availability of each item in the delivery order at each potential warehouse at a particular day and/or time. The machine-learned item availability model 216 predicts 408 the probability that one of the set of items in the delivery order is available at the warehouse. If a number of different warehouses are identified 404, then the machine-learned item availability model 216 predicts the item availability for each one. In some examples, the probability that an item is available includes a probability confidence score generated by the machine-learned item availability model 216.

The order fulfillment engine 206 uses the probability to generate 410 an instruction to a shopper. The order fulfillment engine 206 transmits the instruction to the shopper through the SMA 112 via the shopper management engine 210. The instruction is based on the predicted probability. In some examples, the shopper management engine 210 instructs the shopper to pick an item in the delivery order at a warehouse with the highest item availability score. For example, if a warehouse is more likely to have more items in the delivery order available than another warehouse, then the shopper management engine 210 instructs the shopper to pick the item at the warehouse with better availability. In some other examples, the order fulfillment engine 206 sends a message and/or instruction to a user based on the probability predicted by the machine-learned item availability model 216.

Selecting Items for a Receiving User from a List of Items Obtained from a Sending Entity

FIG. 5 is a flowchart of one embodiment of a method for an online concierge system 102 selecting one or more items for a receiving user based on a list of items obtained from a sending entity. In various embodiments, the method includes different or additional steps than those described in conjunction with FIG. 5. Further, in some embodiments, the steps of the method may be performed in different orders than the order described in conjunction with FIG. 5. The method described in conjunction with FIG. 5 may be carried out by the online concierge system 102 in various embodiments.

The online concierge system 102 receives 505 a list of items from a sending entity of the online concierge system 102. The list includes information identifying one or more items. Example information identifying an item includes an item identified maintained by the online concierge system 102, a name of an item, a description of an item, or any other suitable information. In various embodiments, the online concierge system 102 receives 505 an identifier or a name of the list from the sending entity as well. The online concierge system 102 stores the list in association with the sending entity. The list may identify one or more specific items and one or more generic item descriptions in various embodiments. The sending entity may be a user of the online concierge system 102, a third party system external to the online concierge system 102, or any other suitable source of content.

To allow other users of the online concierge system 102 to readily view or access the list, the online concierge system 102 generates 510 a link to access the list. For example, the link is a hyperlink to a web page generated by the online concierge system 102 or a deep link to a page of content within an application associated with the online concierge system 102, allowing a user of a client device displaying the link to access. Alternatively or additionally, the link comprises a bar code or a QR code that, when accessed by an application executing on a client device retrieves a page of content generated by the online concierge system 102 via an application executing on the client device. The online concierge system 102 transmits or otherwise provides the generated link to the sending entity, allowing the sending entity to distribute the generated list to other users. In various embodiments, the generated link is transmissible by the sending entity to other users through any suitable communication channel, including communication channels external to the online concierge system 102. This allows the sending entity to transmit the list to other users through an application associated with the online concierge system 102 executing on client devices, as well as through communication channels external to an application associated with the online concierge system executing on client devices. For example, the sending entity transmits the link to other users via email or text messaging. The sending entity may additionally or alternatively display the link in one or more web pages served from one or more third party systems external to the online concierge system 102; the link may be displayed in a web page served by a third party system in any suitable format, such as a displayed link, a button or other interface element, or embedded as an iframe including the list from a domain associated with the online concierge system 102 in a page of content from a domain external to the online concierge system 102. When the link is a bar code, a QR code, or other machine readable code, the sending entity may display the bar code, QR code, or other machine readable code on physical objects (e.g., packaging of an item, a poster, a wall of a retailer 110, or any other suitable physical content) or in visual media (e.g., video content, a picture or an image, broadcast media, etc.).

When a receiving user selects the link to access the list, the online concierge system 102 receives 515 a selection of the list that includes information identifying the receiving user and identifying the list. For example, the selection includes an email address of the receiving user or other information identifying the receiving user to the online concierge system 102. As the receiving user may be in a different location than the sending entity, with different warehouses 110 available to the receiving user, items identified by the list may be inaccessible or unavailable to the receiving user. Similarly, for generic item descriptions included in the list, differences in warehouses 110 available to the receiving user affect specific items available that satisfy a generic item description.

To compensate for differences in item availability between a location of the sending entity who created the list and a receiving user, the online concierge system 102 retrieves 520 information maintained by the online concierge system 102 for the receiving user. The retrieved information includes a location of the receiving user, and may include one or more preferences of the user and prior orders the online concierge system 102 received from the receiving user. The receiving user's location may be retrieved 520 from an account the online concierge system 102 maintains for the receiving user. This allows the online concierge system 102 to leverage information about the receiving user to replace or modify an item included on the list with a comparable item that has a higher probability of being available in the receiving user's location or that satisfies one or more preferences of the receiving user.

From the location for the receiving user, the online concierge system 102 selects a warehouse 110 for the receiving user. For example, the online concierge system 102 selects a warehouse 110 identified by a maximum number of orders the online concierge system 102 retrieved from the receiving user (e.g., identified by a maximum number of orders the online concierge system 102 received from the receiving user within a specific time interval). If the online concierge system 102 has received less than a threshold number of orders from the online concierge system 102, the online concierge system 102 determines a geographic region including the location for the receiving user and selects a warehouse 110 included in a maximum number of orders specifying locations within the geographic region. Alternatively, the online concierge system 102 receives a selection of a warehouse 110 from the receiving user.

Based on the retrieved information maintained for the receiving user, for each item of the list the online concierge system 102 selects 525 a set of user-specific items associated with an item included in the list and selects 530 a user-specific item from the set corresponding to the item of the list. In various embodiments, the online concierge system 102 selects 525 the set of user-specific items based on availabilities of items at a warehouse 110 selected for the receiving user. Based on the warehouse 110 selected for the receiving user, the online concierge system 102 determines an availability of the item included in the list by applying the machine-learned item availability model 216 to the combination of selected warehouse 110 and item included in the list. In response to the availability of the item included in the list at the selected warehouse 110 equaling or exceeding a threshold availability, the online concierge system 102 selects 525 the item included on the list as the user-specific item.

However, in response to the availability of the item included in the list at the selected warehouse 110 being less than the threshold availability, the online concierge system 102 selects a set of user-specific items corresponding to the item included in the list. For example, the online concierge system 102 retrieves information stored in association with the item included in the list previously purchased by the receiving user and selects 525 one or more replacement items stored in association with the receiving user for the item included in the list. The online concierge system 102 may account for probabilities of the receiving user purchasing various replacement items if multiple replacement items are stored in association with the receiving user.

Additionally or alternatively, the online concierge system 102 retrieves a taxonomy of items offered by the selected warehouse 110 for the receiving user from an item catalog received from the selected warehouse 110, with different levels in the taxonomy providing different levels of specificity about items included in the levels. In various embodiments, the taxonomy identifies a generic item description and associates one or more specific items with the generic item identifier. For example, a generic item description identifies “milk,” and the taxonomy associates identifiers of different milk items (e.g., milk offered by different brands, milk having one or more different attributes, etc.), with the generic item identifier. Thus, the taxonomy maintains associations between a generic item description and specific items offered by the selected warehouse 110 marching the generic item description. In some embodiments, different levels in the taxonomy identify items with differing levels of specificity based on any suitable attribute or combination of attributes of the items. For example, different levels of the taxonomy specify different combinations of attributes for items, so items in lower levels of the hierarchical taxonomy have a greater number of attributes, corresponding to greater specificity in a generic item description, while items in higher levels of the hierarchical taxonomy have a fewer number of attributes, corresponding to less specificity in a generic item description. In various embodiments, higher levels in the taxonomy include less detail about items, so greater numbers of items are included in higher levels (e.g., higher levels include a greater number of items satisfying a broader generic item description). Similarly, lower levels in the taxonomy include greater detail about items, so fewer numbers of items are included in the lower levels (e.g., higher levels include a fewer number of items satisfying a more specific generic item description). The taxonomy may be received from the selected warehouse 110 in various embodiments. In other embodiments, the online concierge system 102 maintains the taxonomy and applies a trained classification module to an item catalog received from the selected warehouse 110 to include different items in levels of the taxonomy, so application of the trained classification model associates specific items with generic item descriptions corresponding to levels within the taxonomy. In some embodiments, the online concierge system 102 stores different taxonomies that each correspond to a specific warehouse 110 and retrieves a taxonomy stored by the online concierge system 102 corresponding to the selected warehouse 110 for the receiving user.

From the retrieved taxonomy, the online concierge system 102 determines a generic item description corresponding to an item included on the list and selects 525 the set of user-specific items as other items associated with the generic item description corresponding to the item included on the list from the taxonomy. In some embodiments, the online concierge system 102 retrieves prior orders received from the receiving user (e.g., orders received by the online concierge system 102 from the receiving user within a specific time interval from the user) and selects 430 a user-specific item of the set included in a maximum number or in a maximum percentage of the prior orders received from the receiving user. Alternatively, the online concierge system 102 selects 430 a user-specific item of the set of user-specific items included in a prior order most recently received by the online concierge system 102 from the user. In other embodiments, the online concierge system 102 applies the machine-learned item availability model 216, further described above in conjunction with FIG. 2 to the user-specific items of the set and the warehouse 110 selected for the receiving user to determine a predicted availability of different user-specific items of the set at the warehouse 110 identified for fulfilling the order. In various embodiments, the online concierge system 102 identifies a group of user-specific items of the set having at least a threshold availability and selects 530 a user-specific item having at least a threshold position in the ranking or having a maximum availability.

In other embodiments, the online concierge system 102 applies a trained purchase model to user-specific items of the user-specific item set. The trained purchase model outputs a probability of the receiving user purchasing an item. The trained purchase model accounts for times when the receiving user previously purchased an item, such as a relative time from a previously received order including the item to a time when the model is applied, as well as attributes of the item (e.g., a type of the item, a quantity or an amount of the item that was previously purchased, a brand of the item). The trained purchase model may include a decay constant that decreases a weighting of purchases of the items over time, so purchases of the item at longer time intervals from the time when the trained purchase model is applied have lower weights than weights of purchases at the item at shorter time intervals from the time when the trained purchase model is applied. Additionally, the trained purchase model accounts for a frequency with which the receiving user purchases an item, which increases a likelihood of the receiving user purchasing an item if the receiving user more frequently purchases the item. Other example factors used by the trained purchase model to determine the likelihood of a receiving user purchasing an item include: a time interval between prior orders including the item received from the receiving user, a frequency with which the item is included in prior orders received from the receiving user, times when orders including the item were previously received from the receiving user, preferences of the receiving user, and any other suitable information. The trained purchase model may be trained using any suitable method or combination of methods (e.g., supervised learning, unsupervised learning, semi-supervised learning, etc.). In some embodiments, the online concierge system 102 applies the trained purchase model to each combination of the receiving user and a user-specific item of the set of user-specific items and selects 530 an user-specific item of the set having a maximum probability of being purchased by the receiving user. This allows the online concierge system 102 to select 530 a user-specific item of the set that the receiving user is most likely to purchase based on prior orders in which items were purchased by the receiving user. In some embodiments, the trained purchase model accounts for a difference between a probability of the receiving user purchasing a user-specific item of the set that was included one or more previous orders and a probability of the receiving user purchasing a different user-specific item of the set. For example, the online concierge system 102 ranks other user-specific items within the set based on differences between a probability of the receiving user purchasing a receiving user specified item within the set and a probability of the receiving user purchasing a user-specific item of the set that was previously purchased by the receiving user (e.g., an item that was most recently purchased by the receiving user) so items having smaller differences have higher positions in the ranking. The online concierge system 102 selects 530 a user-specific item of the set having at least a threshold position in the ranking. This allows the online concierge system 102 to maximize a probability of the receiving user purchasing a user-specific item of the set when a user-specific item of the set differing from a user-specific item included in a previous order from the receiving user is selected 530.

In some embodiments, an entity associated with a user-specific item in the set or the sending entity from whom the online concierge system 102 received 505 the list provides the online concierge system 102 with compensation for selecting 530 the user-specific item from the set. Example entities associated with an item include a warehouse 110 from which the item is obtained, a manufacturer of the item, a brand offering the item, or any other suitable entity. The online concierge system 102 receives compensation from the entity, or from the sending entity, for selecting 530 the user-specific item in some embodiments. Alternatively, the online concierge system 102 receives compensation from the entity, or from the sending entity, for the receiving user completing an order and purchasing the user-specific item. The online concierge system 102 may account for compensation received from one or more entities, or from the sending entity, when selecting 530 a user-specific item of the set. For example, the online concierge system 102 determines expected values for various user-specific items of the set for which the online concierge system 102 receives compensation as a product of an amount of compensation received for selecting 530 a user-specific item and a probability of the receiving user purchasing the user-specific item. The online concierge system 102 selects 530 a user-specific item of the set having a maximum expected value or ranks user-specific items of the set by their corresponding expected values and selects 530 a user-specific item having at least a threshold position in the ranking (e.g., having a maximum position in the ranking). In some embodiments, the online concierge system 102 converts a probability of the receiving user purchasing a user-specific item and an amount of compensation the online concierge system 102 receives for selecting 530 the item into a common unit of measurement. For example, the online concierge system 102 applies a conversion factor to the probability of the receiving user purchasing a user-specific item of the set that converts the probability of the receiving user purchasing the user-specific item to an organic amount of compensation. Alternatively, the online concierge system 102 applies a conversion factor to the amount of compensation the online concierge system 102 received for selecting 530 the user-specific item of the set to a probability. Converting the amount of compensation received by the online concierge system 102 for selecting 530 the user-specific item and the probability of the receiving user purchasing the user-specific item into a common unit of measurement allows the online concierge system 102 to calculate a value for each user-specific item of the set, both user-specific items for which the online concierge system 102 receives compensation for selecting 530 and user-specific items for which the online concierge system 102 does not receive compensation for selecting 530. The online concierge system 102 ranks the user-specific items of the set based on their corresponding values and selects 530 a user-specific item of the set having at least a threshold position in the ranking (e.g., a maximum position in the ranking) or selects 530 a user-specific item of the set having a maximum value.

In some embodiments, the sending entity specifies one or more items in the list as unable to be replaced. For an item specified as unable to replaced, the online concierge system 102 selects 530 the item in the list as the user-specific item for the item in the list. This prevents the online concierge system 102 from replacing certain items identified by the sending entity with other user-specific items, allowing the sending entity to encourage purchase of one or more items specified as unable to be replaced or to increase awareness of one or more items included in the list that are specified as unable to be replaced.

For a generic item description included in the list, the online concierge system 102 selects 525 the set of user-specific items associated with the generic item description from the retrieved taxonomy. In various embodiments, the set of user-specific items includes each specific item associated with the generic item description by the retrieved taxonomy. The online concierge system 102 may account for prior inclusion of user-specific items within associated with the generic item description by other users of the online concierge system 102. For example, the online concierge system 102 selects 525 a set of user-specific items associated with the generic item description that were included in at least a threshold number or a threshold percentage of orders previously received from users (e.g., orders received by the online concierge system 102 within a specific time interval). The online concierge system 102 may account for the location determined for the receiving user when selecting 525 the set of user-specific items in some embodiments so the set includes specific items associated with the generic item description that were included in at least at a threshold number or a threshold percentage of previously received orders (e.g., orders received by the online concierge system 102 within a specific time interval) that identified locations within a threshold distance of the location determined for the receiving user.

In some embodiments, the online concierge system 102 retrieves prior orders received from the receiving user (e.g., orders received by the online concierge system 102 from the receiving user within a specific time interval from the user) and selects 530 a user-specific item of the set included in a maximum number or in a maximum percentage of the prior orders received from the receiving user. Alternatively, the online concierge system 102 selects 530 a user-specific item of the set included in a prior order most recently received by the online concierge system 102 from the receiving user.

In other embodiments, the online concierge system 102 applies a trained purchase model to user-specific items of the set. As further described above, the trained purchase model outputs a probability of the receiving user purchasing an item. The online concierge system 102 may apply the trained purchase model to each combination of the receiving user and a user-specific item of the set and selects 530 a user-specific item of the set having a maximum probability of being purchased by the receiving user. This allows the online concierge system 102 to select 530 a user-specific item of the set that the receiving user is most likely to purchase based on prior orders in which items were purchased by the receiving user. In some embodiments, the trained purchase model accounts for a difference between a probability of the receiving user purchasing a user-specific item of the set that was included one or more previous orders and a probability of the receiving user purchasing a different user-specific item of the set. For example, the online concierge system 102 ranks other user-specific items within the set based on differences between a probability of the receiving user purchasing a user-specific item within the set and a probability of the receiving user purchasing a user-specific item of the set that was previously purchased by the receiving user (e.g., a user-specific item that was most recently purchased by the receiving user) so user-specific items having smaller differences have higher positions in the ranking. The online concierge system 102 selects 530 a user-specific item of the set having at least a threshold position in the ranking. This allows the online concierge system 102 to maximize a probability of the receiving user purchasing a user-specific item of the set when a user-specific item of the set differing from a user-specific item included in a previous order from the receiving user is selected 530.

The online concierge system 102 applies the machine-learned item availability model 216, further described above in conjunction with FIG. 2 to the user-specific items of the set for the generic item description included in the list and the warehouse 110 selected for the receiving user to determine a predicted availability of different user-specific items of the at the warehouse 110 identified for fulfilling the order. In various embodiments, the online concierge system 102 identifies a group of user-specific items of the set having at least a threshold availability and ranks the user-specific items of the group based on probabilities of the receiving user purchasing each user-specific item of the group; the online concierge system 102 selects 530 a user-specific item of the group having at least a threshold probability of being purchased by the receiving user or having at least a threshold position (e.g., a maximum position) in the ranking based on their probabilities or being purchased by the receiving user. In another embodiment, the online concierge system 102 ranks user-specific items of the set based on their predicted availabilities and identifies a group of user-specific items of the set having at least a threshold position in the ranking; the online concierge system 102 selects 530 a user-specific item of the group having a maximum probability of being purchased by the receiving user. Alternatively, the online concierge system 102 retrieves information stored in association with a user-specific item of the set previously purchased by the receiving user and selects 530 a replacement item stored in association with the receiving user for the identified user-specific item. The online concierge system 102 may account for probabilities of the receiving user purchasing various replacement items of the set if multiple replacement items of the set for a user-specific item of the set previously purchased by the receiving user are stored in association with the receiving user (e.g., by selecting 430 a replacement item of the set having a maximum probability of being purchased by the receiving user).

In some embodiments, an entity associated with a user-specific item in the set, or the sending entity from whom the online concierge system 102 received the list, provides the online concierge system 102 with compensation for selecting 530 the user-specific item from the set. Example entities associated with a user-specific item include a warehouse 110 from which the user-specific item is obtained, a manufacturer of the user-specific item, a brand offering the user-specific item, or any other suitable entity. The online concierge system 102 receives compensation from the entity, or from the sending entity from whom the list was obtained, for selecting 530 the item in some embodiments. Alternatively, the online concierge system 102 receives compensation from the entity, or from the sending entity from whom the list was obtained, for the receiving user completing an order and purchasing the user-specific item. The online concierge system 102 may account for compensation received from one or more entities, or from the sending entity, when selecting 530 a user-specific item of the set. For example, the online concierge system 102 determines expected values for various user-specific items of the set for which the online concierge system 102 receives compensation as a product of an amount of compensation received for selecting 530 a user-specific item and a probability of the receiving user purchasing the item. The online concierge system 102 selects 530 a user-specific item of the set having a maximum expected value or ranks user-specific items of the set by their corresponding expected values and selects 530 an user-specific item having at least a threshold position in the ranking (e.g., having a maximum position in the ranking). In some embodiments, the online concierge system 102 converts a probability of the receiving user purchasing an item and an amount of compensation the online concierge system 102 receives for selecting 530 the user-specific item into a common unit of measurement. For example, the online concierge system 102 applies a conversion factor to the probability of the receiving user purchasing a user-specific item of the set that converts the probability of the receiving user purchasing the item to an organic amount of compensation. Alternatively, the online concierge system 102 applies a conversion factor to the amount of compensation the online concierge system 102 received for selecting 530 the user-specific item of the set to a compensated probability. Converting the amount of compensation received by the online concierge system 102 for selecting the user-specific item and the probability of the receiving user purchasing the user-specific item into a common unit of measurement allows the online concierge system 102 to calculate a value for each user-specific item of the set, both user-specific items for which the online concierge system 102 receives compensation for selecting 530 and user-specific items for which the online concierge system 102 does not receive compensation for selecting 530. The online concierge system 102 ranks the items of the user-specific set based on their corresponding values and selects 530 a user-specific item of the set having at least a threshold position in the ranking (e.g., a maximum position in the ranking) or selects 530 a user-specific item of the set having a maximum value.

From the user-specific items selected 530 by the online concierge system 102 for items included in the list, the online concierge system 102 generates 535 a user-specific list. The user-specific list identifies the user-specific items selected 530 for the receiving user for each item included on the list. When the list includes one or more items specified as unable to be replaced, the user-specific list identifies the items specified as unable to be replaced that were included in the list by the sending entity. The online concierge system 102 subsequently transmits 540 an interface describing the user-specific list to a client device of the receiving user for display. For example, the interface includes names or descriptions of each user-specific item included in the user-specific list, and may include one or more images of user-specific items included in the user-specific list. The interface also identifies the warehouse 110 selected for the receiving user In various embodiments, the interface includes an interface element, such as a button or a link, that, when selected by the receiving user includes each item in the user-specific list in an order for fulfillment by the online concierge system 102. This allows the receiving user to generate an order for the user-specific items from the user-specific list with a single interaction with the online concierge system 102, simplifying order creation by the receiving user. Additionally, the interface allows the receiving user to modify the user-specific list by removing items from or adding items to the user-specific list or by replacing a user-specific item in the user-specific list with an alternative item. The receiving user may subsequently select the interface element to include the items in the modified user-specific list in an order for fulfillment by the online concierge system 102.

FIG. 6 is a conceptual diagram of an online concierge system 102 selecting one or more items for a receiving user based on a list of items obtained from a sending entity. In the example of FIG. 6, the online concierge system 102 receives a list 600 of items from a sending entity. For purposes of illustration, FIG. 6 shows the list 600 including item 605 and item 610, but in other embodiments, the list 600 includes any number of items. Additionally, the list 600 may include one or more generic item descriptions, as further described above in conjunction with FIG. 5. The online concierge system 102 generates a link that, when selected, allows other users to access the list 600. In various embodiments, the online concierge system 102 generates the link in response to receiving a request to generate the link from the sending entity.

When a receiving user selects the link to access the list 600, rather than display the list 600 received from the sending entity to the receiving user, the online concierge system 102 uses the items (e.g., item 605, item 610) included in the list 600 by the sending entity and information maintained by the online concierge system 102 to modify one or more items in the list 600 to account for availability of items at a location of the receiving user or to account for one or more preferences of the receiving user. This allows the online concierge system 102 to alter the list 600 from the sending entity to account for factors specific to the receiving user, increasing a likelihood of the receiving user including items in an order.

For each item of the list 600, the online concierge system 102 identifies a set 615 or user-specific items, as further described above in conjunction with FIG. 2. For example, the online concierge system 102 selects a warehouse 110 for the receiving user based on a location of the receiving user (or receives a selection of a warehouse 110 from the receiving user) and retrieves a taxonomy maintaining associations between different generic item descriptions and different specific items for the warehouse 110. The set 615 of user-specific items includes items associated with a common generic item description as an item on the list 600. In the example of FIG. 615, the online concierge system 102 identifies a generic item description associated with item 605 from a taxonomy for a warehouse 110, and selects the set 615 of user-specific items for item 605 as item 605, item 620, and item 625, which are each associated with the identified generic item description in the taxonomy for the warehouse 110. While FIG. 6 shows the set 615 of user-specific items including item 605, item 620, and item 625, the set 615 of user-specific items may include any number of items.

The online concierge system 102 selects an item of the set 615 of user-specific items for inclusion in a user-specific list 630 generated from the list 600 received from the sending entity. For example, the online concierge system 102 selects an item 605, 620, 625 from set 615 of user-specific items that was previously included in one or more orders received from the receiving user. However, as further described above in conjunction with FIG. 5, the online concierge system 102 may select one of item 605, 620, and 625 based on one or more criteria. For example, the online concierge system 102 accounts for predicted availability of each item 605, 620, 625 included in the set 615 of user-specific items and may account for a probability of the user purchasing each of item 605, 620, and 625 when selecting an item from the set 615 of user-specific items for inclusion in the user-specific list 630.

In the example of FIG. 6, the online concierge system 102 selects item 620 from the set 615 of user-specific items using one or more selection criteria further described above in conjunction with FIG. 5. Hence, the user-specific list 630 replaces item 605 from the list 600 received from the sending entity with item 620, accounting for information specific to the receiving user maintained by the online concierge system 102. The online concierge system 102 selects a replacement user specific item for each item included in the list 600 from the sending entity, as further described above in conjunction with FIG. 5. One or more of the items included in the list 600 from the sending entity may be selected as the user-specific items for the user-specific list. In the example of FIG. 6, the online concierge system 102 selected item 610, which was included in the list 600 from the sending entity, for inclusion in the user-specific list 630.

To simplify creation of an order from the user-specific list 630, when displaying the user-specific list 630 in an interface to the receiving user that is prepopulated with information describing each item (e.g., item 620, item 610) included in the user-specific list 630. For example, the interface includes a name and an image of items 610 and 620, but may include any suitable information identifying items 610 and 620 in various embodiments. The interface includes additional elements in various embodiments. For example, the interface shown in FIG. 6 includes a removal element 635 in conjunction with each item 610 and 620 that, when selected by the user, removes an item 610 and 620 corresponding to the selected removal element 635 from the user-specific list 630. Similarly, the interface includes an addition element 540 that, when selected by the receiving user, prompts the receiving user to enter a search query or other information for selecting another item to include in the user-specific list 630. Additionally, the interface includes an order creation element 645 that, when selected by the receiving user, generates an order including each item of the user-specific list 630 for fulfillment by the online concierge system 102. Hence, the online concierge system 102 allows the receiving user to provide a single input, via the order creation element 645, to generate an order including multiple items the online concierge system 102 selects for the receiving user from the list 600 obtained from a sending entity and information about the receiving user maintained by the online concierge system 102. This allows the online concierge system 102 to streamline creation of an order by allowing the online concierge system 102 to leverage items included in a list 600 created by a sending entity and information maintained for the receiving user to select items specific to the receiving user that are identified via a user-specific list 630 in an interface allowing the receiving user to include each of the user-specific items corresponding to items in the list 600 from the sending entity in an order. This reduces an amount of interaction with the online concierge system 102 by the receiving user (e.g., a number of queries provided to the online concierge system 102, a number of interfaces for the user to navigate through) to create an order for fulfillment by the online concierge system 102.

### Additional Considerations

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium, which include any type of tangible media suitable for storing electronic instructions and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
receiving, at the online concierge system, a list of one or more items from a sending entity;
generating, by the online concierge system, a link to access the list for display;
receiving a selection of the link by a receiving user of the online concierge system, the selection including information identifying the receiving user and the receiving user different from the sending entity;
for each item included in the list:
identifying, by the online concierge system, a set of user-specific items associated with an item included in the list based on a location of the receiving user and information about the receiving user maintained by the online concierge system;
selecting, by the online concierge system, a user-specific item from the set; and
generating, by the online concierge system, a user-specific list including the user-specific item selected for each item included in the list; and
transmitting an interface identifying the user-specific list to a client device of the receiving user for display.

2. The method of claim 1, wherein identifying, by the online concierge system, the set of user-specific items associated with the item included in the list based on the location of the receiving user and information about the user maintained by the online concierge system comprises:
selecting a warehouse for the receiving user based on the location of the receiving user;
retrieving a taxonomy for the selected warehouse, the taxonomy associating one or more generic item descriptions with one or more specific items offered for purchase by the selected warehouse; and
selecting the set of user-specific items as items associated with a generic item description of the item included in the list by the taxonomy for the selected warehouse.

3. The method of claim 1, wherein selecting, by the online concierge system, the user-specific item from the set comprises:
selecting a warehouse for the receiving user based on the location of the receiving user;
retrieving prior orders the online concierge system received from the receiving user; and
selecting a user-specific item from the set included in a maximum amount of the prior orders received from the receiving user.

4. The method of claim 1, wherein selecting, by the online concierge system, the user-specific item from the set comprises:
selecting a warehouse for the receiving user based on the location of the receiving user;
retrieving prior orders the online concierge system received from the receiving user; and
selecting a user-specific item from the set included in a prior order most recently received from the receiving user.

5. The method of claim 1, wherein selecting, by the online concierge system, the user-specific item from the set comprises:
determining a probability of the receiving user purchasing each user-specific item of the set; and
selecting a user-specific item having a maximum probability of being purchased by the receiving user from the set.

6. The method of claim 5, wherein determining the probability of the receiving user purchasing each user-specific item in the set comprises:
applying a trained purchase model to each combination of the receiving user and the user-specific item of the set, the trained purchase model generating the probability of the user purchasing the user-specific item in the set based on attributes of the user-specific item of the set and items included in orders the online concierge system previously received from the receiving user.

7. The method of claim 1, wherein selecting, by the online concierge system, the user-specific item from the set comprises:
determining a predicted availability of each user-specific item of the set at a warehouse for the receiving user based on the location of the receiving user;
identifying a group of user-specific items of the set having at least a threshold predicted availability; and
selecting a user-specific item of the group having at least a threshold probability of being purchased by the receiving user.

8. The method of claim 1, wherein selecting, by the online concierge system, the user-specific item from the set comprises:
determining a predicted availability of each user-specific item of the set at a warehouse for the receiving user based on the location of the receiving user;
ranking user-specific items of the set based on their predicted availabilities;
identifying a group of user-specific items of the set having at least a threshold position in the ranking; and
selecting a user-specific item of the group having a maximum probability of being purchased by the user.

9. The method of claim 1, wherein identifying, by the online concierge system, the set of user-specific items associated with the item included in the list based on the location of the receiving user and information about the user maintained by the online concierge system comprises:
in response to identifying a generic item description included in the list:
selecting a warehouse for the receiving user based on the location of the receiving user;
retrieving a taxonomy for the selected warehouse, the taxonomy associating one or more generic item descriptions with one or more specific items offered for purchase by the selected warehouse; and
selecting the set of user-specific items as items associated with the generic item description included in the list by the taxonomy for the selected warehouse.

10. The method of claim 1, wherein selecting, by the online concierge system, the user-specific item from the set comprises:
retrieving an amount of compensation the online concierge system receives from the sending entity for selecting a user-specific item of the set;
determining a probability of the receiving user purchasing each user-specific item of the set;
converting the amounts of compensation the online concierge system receives for selecting the user-specific item of the set and the determined probabilities into a common unit of measurement;
calculating a value for each user-specific item of the set by combining the converted amounts of compensation the online concierge system receives and the determined probabilities into a common unit of measurement; and
selecting the user-specific item of the set based on the calculated values.

11. The method of claim 1, wherein selecting, by the online concierge system, the user-specific item from the set comprises:
selecting the user-specific item as the item included in the list in response to the sending entity specifying that the item included in the list is unable to be replaced.

12. The method of claim 1, wherein the link comprises a bar code or a QR code.

13. The method of claim 1, wherein the interface includes an interface element that, when selected by the receiving user, generates an order including the user-specific items in the user-specific list for fulfillment by the online concierge system.

14. A computer program product comprising a non-transitory computer readable storage medium having instructions encoded thereon that, when executed by a processor, cause the processor to:
receive, at the online concierge system, a list of one or more items from a sending entity of the online concierge system;
generate, by the online concierge system, a link to access the list for display;
receive a selection of the link by a receiving user of the online concierge system, the selection including information identifying the receiving user and the receiving user different from the sending entity;
for each item included in the list:
identify, by the online concierge system, a set of user-specific items associated with an item included in the list based on a location of the receiving user and information about the receiving user maintained by the online concierge system;
select, by the online concierge system, a user-specific item from the set; and
generate, by the online concierge system, a user-specific list including the user-specific item selected for each item included in the list; and
transmit an interface identifying the user-specific list to a client device of the receiving user for display.

15. The computer program product of claim 14, wherein identify, by the online concierge system, the set of user-specific items associated with the item included in the list based on the location of the receiving user and information about the user maintained by the online concierge system comprises:
select a warehouse for the receiving user based on the location of the receiving user;
retrieve a taxonomy for the selected warehouse, the taxonomy associating one or more generic item descriptions with one or more specific items offered for purchase by the selected warehouse; and
select the set of user-specific items as items associated with a generic item description of the item included in the list by the taxonomy for the selected warehouse.

16. The computer program product of claim 14, wherein select, by the online concierge system, the user-specific item from the set comprises:
select a warehouse for the receiving user based on the location of the receiving user;
retrieve prior orders the online concierge system received from the receiving user; and
select a user-specific item from the set included in a maximum amount of the prior orders received from the receiving user.

17. The computer program product of claim 14, wherein select, by the online concierge system, the user-specific item from the set comprises:
select a warehouse for the receiving user based on the location of the receiving user;
retrieve prior orders the online concierge system received from the receiving user; and
select a user-specific item from the set included in a prior order most recently received from the receiving user.

18. The computer program product of claim 14, wherein select, by the online concierge system, the user-specific item from the set comprises:
determine a probability of the receiving user purchasing each user-specific item of the set; and
select a user-specific item having a maximum probability of being purchased by the receiving user from the set.

19. The computer program product of claim 18, wherein determine the probability of the receiving user purchasing each user-specific item in the set comprises:
apply a trained purchase model to each combination of the receiving user and the user-specific item of the set, the trained purchase model generating the probability of the user purchasing the user-specific item in the set based on attributes of the user-specific item of the set and items included in orders the online concierge system previously received from the receiving user.

20. The computer program product of claim 14, wherein select, by the online concierge system, the user-specific item from the set comprises:
determine a predicted availability of each user-specific item of the set at a warehouse for the receiving user based on the location of the receiving user;
identify a group of user-specific items of the set having at least a threshold predicted availability; and
select a user-specific item of the group having at least a threshold probability of being purchased by the receiving user.

21. The computer program product of claim 14, wherein select, by the online concierge system, the user-specific item from the set comprises:
determine a predicted availability of each user-specific item of the set at a warehouse for the receiving user based on the location of the receiving user;
rank user-specific items of the set based on their predicted availabilities;
identify a group of user-specific items of the set having at least a threshold position in the ranking; and
select a user-specific item of the group having a maximum probability of being purchased by the user.

22. The computer program product of claim 14, wherein identify, by the online concierge system, the set of user-specific items associated with the item included in the list based on the location of the receiving user and information about the user maintained by the online concierge system comprises:
in response to identifying a generic item description included in the list:
select a warehouse for the receiving user based on the location of the receiving user;
retrieve a taxonomy for the selected warehouse, the taxonomy associating one or more generic item descriptions with one or more specific items offered for purchase by the selected warehouse; and
select the set of user-specific items as items associated with the generic item description included in the list by the taxonomy for the selected warehouse.

23. The computer program product of claim 14, wherein select, by the online concierge system, the user-specific item from the set comprises:
retrieve an amount of compensation the online concierge system receives from the sending entity for selecting a user-specific item of the set;
determine a probability of the receiving user purchasing each user-specific item of the set;
convert the amounts of compensation the online concierge system receives for selecting the user-specific item of the set and the determined probabilities into a common unit of measurement;
calculate a value for each user-specific item of the set by combining the converted amounts of compensation the online concierge system receives and the determined probabilities into a common unit of measurement; and
select the user-specific item of the set based on the calculated values.

24. The computer program product of claim 14, wherein select, by the online concierge system, the user-specific item from the set comprises:
select the user-specific item as the item included in the list in response to the sending entity specifying that the item included in the list is unable to be replaced.

25. The computer program product of claim 14, wherein the link comprises a bar code or a QR code.

26. The computer program product of claim 14, wherein the interface includes an interface element that, when selected by the receiving user, generates an order including the user-specific items in the user-specific list for fulfillment by the online concierge system.
